(19) United States
(12) Patent Application Publication
(10) Pub. No.: US 2014/0004985 A1
(43) Pub. Date: Jan. 2, 2014

(54) TENSION ROLLER FOR A BELT DRIVE OF AN INTERNAL COMBUSTION ENGINE

(71) Applicants: Romuald Lescorail, St. Laurent en Gatines (FR); Nicolas Tronquoy, Fondettes (FR)

(72) Inventors: Romuald Lescorail, St. Laurent en Gatines (FR); Nicolas Tronquoy, Fondettes (FR)

(73) Assignee: AKTIEBOLAGET SKF, Goteborg (SE)

(21) Appl. No.: 13/932,102

(22) Filed: Jul. 1, 2013

(30) Foreign Application Priority Data
Jun. 29, 2012 (FR) 12/01849

(51) Int. Cl. F16H 55/36

(52) U.S. Cl. CPC F16H 55/36
USPC 474/166

(57) ABSTRACT

A tension roller or tensioner for a belt drive of an internal combustion engine comprises a pulley (10); at least one rolling bearing (18) comprising an inner race (20) and an outer race (22), the bearing being mounted in the pulley (10); a spacer (12) having a central bore (14) and a shoulder (16) supporting the inner race (20) radially and axially; a screw (24) arranged in the central bore (14) of the spacer (12); an elastic cup (26) for securing the screw (24) in the central bore (14) of the spacer (12) during transport; and a means for sealing the rolling bearing (18) during use.

It is proposed that the one means for sealing the rolling bearing (18) comprise at least one seal integrated into the rolling bearing (18).

### CROSS-REFERENCE

This application claims priority to French patent application no. 12/01849 filed on Jun. 29, 2012, the contents of which are fully incorporated herein by reference.

### TECHNICAL FIELD

The present invention relates to a tension roller or tensioner for a belt drive of an internal combustion engine.

### BACKGROUND

Belt drives for driving secondary assemblies of an internal combustion engine comprise rollers fastened to the engine block and rollers, preloaded by a spring, acting in a pivoting manner on a drive belt.

In order to ensure sufficiently precise mounting position and orientation of these rollers, it is known to provide a spacer having a central bore and a shoulder supporting the inner race radially and axially. The roller is bolted to the engine block or to another axial support means with a screw which passes through the central bore of the spacer such that the inner race and the spacer are clamped between the head of the screw and the engine block.

The roller with the rolling bearing, the shoulder and the screw are pre-assembled at the premises of the manufacturer of the roller and are delivered as a construction module to the site where the motor vehicle is assembled.

DE 100 03 208 A1 proposes, in order to hold the construction module together during transport between the premises of the manufacturer of the roller and the site where the motor vehicle is assembled, the use of an elastic cup in the shape of an O-ring in order to secure the screw in the central bore of the spacer during transport.

DE 100 03 208 A1 proposes, in order to seal the rolling bearing when in use, using a washer which is clamped by the screw head onto the axial surface of the inner race.

Vibration during transport can cause the O-ring of this construction module to come loose. As a consequence, the washer no longer covers and no longer protects the interior of the rolling bearing and dust in the atmosphere of the assembly site can enter it.

The present invention relates to a tension roller or tensioner for a belt drive of an internal combustion engine in which the rolling bearing is effectively protected from dirt during transport and during installation.

### SUMMARY

The tension roller or tensioner for a belt drive of an internal combustion engine comprises a pulley; at least one rolling bearing comprising an inner race and an outer race, the bearing being mounted in the pulley; a spacer having a central bore and a shoulder supporting the inner race radially and axially; a screw arranged in the central bore of the spacer; an elastic cup for securing the screw in the central bore of the spacer during transport; and a means for sealing the rolling bearing during use.

It is proposed that the one means used for sealing the rolling bearing comprise at least one seal integrated into the rolling bearing.

In one preferred embodiment, the seal integrated into the rolling bearing comprises at least one labyrinth seal. The labyrinth seal preferably comprises seals made of synthetic rubber.

Advantageously, the means used for sealing the rolling bearing comprises at least two seals integrated into both axial sides of the rolling bearing. Thus, both sides of the rolling bearing can be protected.

The pulley is preferably overmoulded onto the outer race of the rolling bearing.

In one preferred embodiment, the screw head is in direct contact with the inner race of the rolling bearing.

### BRIEF DESCRIPTION OF THE DRAWINGS

Other features and advantages of the invention will become clear from the following indicative—and in no way limiting—description thereof, with reference to the appended figures, in which:

FIG. 1 is an axial section through the tension roller or tensioner for a belt drive of an internal combustion engine according to the invention, and

FIG. 2 is a view in perspective of the roller according to FIG. 1.

### DETAILED DESCRIPTION OF THE INVENTION

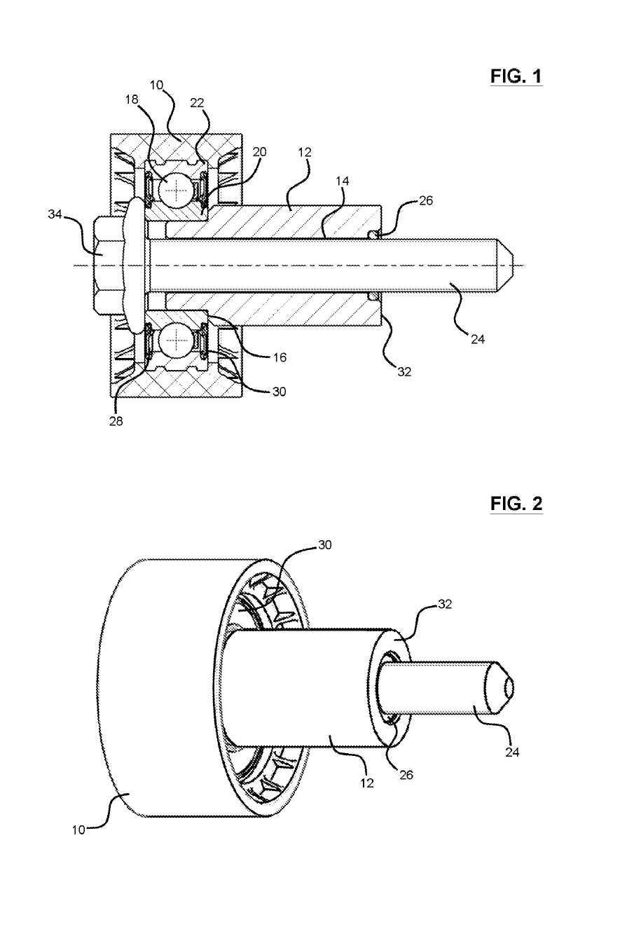

FIG. 1 shows a tension roller or tensioner for a belt drive of an internal combustion engine. The roller is a preassembled module and comprises a pulley 10; a rolling bearing 18 comprising an inner race 20 and an outer race 22, the bearing being mounted in the pulley 10; a spacer 12 having a central bore 14 and a shoulder 16 supporting the inner race 20 radially and axially; a screw 24 arranged in the central bore 14 of the spacer 12; an elastic cup 26 for securing the screw 24 in the central bore 14 of the spacer 12 during transport; and two seals 28, 30 integrated into the rolling bearing 18 in order to protect the interior of the rolling bearing 18 from dirt. The cup 26 is a simple O-ring.

In the embodiment shown, the seals integrated into the rolling bearing 18 comprise a labyrinth seal consisting of toroidal elements which are made of synthetic rubber and are fastened to the outer race 22 and to the inner race 20.

The rolling bearing 18 is a single-row ball bearing having a pitch diameter of 28.5 mm The rolling bearing 18 is lubricated with grease.

The pulley 10 is overmoulded onto the outer race 22 of the rolling bearing 18. The outer radial surface has circumferential grooves in order to better fasten the pulley 10 to the outer race 22. As an alternative, the pulley can be made of pressed sheet metal.

The spacer 12 is a metal bushing having a shoulder 16 formed on a side facing away from the contact surface 32 provided in order to press against the engine block or another support surface. A groove which receives the elastic cup in the form of an O-ring is provided around the edge of the bore 14 which receives the screw 24.

The head 34 of the screw 24 is in direct contact with the inner race 20 of the rolling bearing 18 in order to provide direct transmission of force.

1. A tension roller for a belt drive of an internal combustion engine, comprising:
a pulley;
at least one rolling bearing having an inner race and an outer race, the bearing being mounted in the pulley;
a spacer having a central bore and a shoulder supporting the inner race radially and axially;
a screw arranged in the central bore of the spacer;
an elastic cup for securing the screw in the central bore of the spacer during transport; and
a means for sealing the rolling bearing during use; wherein
the means for sealing the rolling bearing provides at least one seal integrated into the rolling bearing.

2. The tension roller according to claim 1, wherein the seal integrated into the rolling bearing provides at least one labyrinth seal.

3. The tension roller according to claim 2, wherein the labyrinth seals are made up of O-rings made of synthetic rubber.

4. The tension roller according to claim 1, wherein the means for sealing the rolling bearing provides at least two seals integrated into both axial sides of the rolling bearing.

5. The tension roller according to claim 1, wherein the pulley is overmoulded onto the outer race of the rolling bearing.

6. The tension roller according to claim 1, wherein the head of the screw is in direct contact with the inner race of the rolling bearing.
